(19) United States
(12) Patent Application Publication
(10) Pub. No.: US 2012/0056788 A1
(43) Pub. Date: Mar. 8, 2012

(54) MULTIBAND AND BROADBAND ANTENNA USING METAMATERIALS, AND COMMUNICATION APPARATUS COMPRISING THE SAME

(75) Inventors: Byung Hoon Ryou, Seoul (KR); Won Mo Sung, Gyeonggi-do (KR); Jeong Keun Ji, Seoul (KR)

(73) Assignee: EMW CO., LTD., Incheon (KR)

(21) Appl. No.: 13/254,828

(22) PCT Filed: Mar. 2, 2010
(86) PCT No.: PCT/KR2010/001269

§ 371 Date: Nov. 15, 2011

(30) Foreign Application Priority Data
Mar. 2, 2009 (KR) 10-2009-0017608

(51) Int. Cl. H01Q 1/36

(52) U.S. Cl. 343/700 MS

(57) ABSTRACT

A multiband and broadband antenna using metamaterials and a communication apparatus comprising same are provided. According to one embodiment of the present invention, provided is a multiband and broadband antenna, comprising: a feeder unit formed in at least a portion of a carrier; and at least one double negative (DNG) unit cell which is formed in the carrier, fed by the feeder unit, and serves as a composite right/left handed transmission line (CRLH-TL).

### TECHNICAL FIELD

The present invention relates to an antenna and a communication device including the same, in which the antenna can be miniaturized further more and a resonant frequency can be easily tuned using characteristics of a meta material, thereby accomplishing multiband and broadband of the antenna.

### BACKGROUND ART

As communication techniques, especially wireless communication techniques are developed with the advancement in electronic industry, a variety of wireless communication terminals capable of performing voice and data communications with anybody at any time at any place are developed and commonly used.

In addition, a variety of techniques for miniaturizing the wireless communication terminals, e.g., development of large scale integrated circuit elements, methods of miniaturizing electronic circuit boards, and the like, are studied in order to improve portability of the wireless communication terminals, and communication terminals performing a variety of functions, such as navigation terminals, Internet terminals, and the like, are developed as the purpose of using the wireless communication terminals is also diversified.

Meanwhile, one of important techniques in the wireless communication techniques is techniques related to antennas, and antennas based on various techniques, such as coaxial antennas, rod antennas, loop antennas, beam antennas, super gain antennas, and the like, are currently used.

Particularly, as portability and miniaturization of the wireless communication terminals tend to be improved further more recently, techniques for miniaturizing an antenna is required further more, and accordingly, antennas having a wire configured in a helix or meander line form are proposed.

However, the proposed antennas are limited in that the size of an antenna is determined by a resonant frequency, and shapes of the antennas become more complex in order to form an antenna of a fixed length in a narrow space as the antennas are miniaturized further more.

A technique proposed to solve the problem is a technique of an antenna using a meta material.

Here, the meta material is a material or an electromagnetic structure artificially designed to have special electromagnetic characteristics that cannot be generally found in the nature, and the meta material has a special character favorable to miniaturization of an antenna if the characteristics of the meta material are applied to the antenna.

The present invention proposes an antenna system capable of implementing a further miniaturized multiband and broadband antenna by using such a meta material.

### DISCLOSURE OF INVENTION

### Technical Problem

Therefore, the present invention has been made in view of the above problems, and it is an object of the present invention to provide a multiband and broadband antenna using characteristics of a meta material and a communication device including the antenna, in which one or more DNG unit cells are included in the antenna to miniaturize the antenna further more, and a resonant frequency can be easily tuned.

### Technical Solution

According to an embodiment of the present invention for achieving the object, there is provided a multiband and broadband antenna comprising: a power feeding unit formed in at least a portion of a carrier; and at least one Double Negative (DNG) unit cell formed on the carrier, for receiving power from the power feeding unit and functioning as a Composite Right/Left Handed Transmission Line (CRLH-TL).

Two DNG unit cells are formed in the antenna, in which a first DNG unit cell of the two DNG unit cells may be formed on a left side of the power feeding unit and include a first patch and a first stub formed on at least one surface of the carrier, and a second DNG unit cell of the two DNG unit cells may be formed on a right side of the power feeding unit and include a second patch and a second stub formed on at least one surface of the carrier.

The power feeding unit may include a power feeding line of a helical shape, and the power feeding line of a helical shape may be formed to have a first gap to be spaced from the first DNG unit cell to perform coupling power feeding and directly connected to the second DNG unit cell to perform direct power feeding.

A second gap may be formed in at least a portion of the second patch. The first stub and the second stub may be connected to a ground surface formed on a substrate which is formed to be independent from the carrier.

Inductors may be formed between at least one of the power feeding unit, the first stub and the second stub and the ground surface.

The second stub may be a stub of a helical shape, in which one end of the stub is connected to the ground surface, and the other end of the stub is connected to the second patch.

A resonant frequency of the first DNG unit cell is determined by a reactance component of a CRLH-TL structure, and the reactance component may be controlled by adjusting at least one of a position of the power feeding line, a width of the power feeding line, a length of the power feeding line, a distance of the first gap, a size of the first patch, permittivity of the carrier, permeability of the carrier, a size of the carrier, a position of the first stub, a width of the first stub, and a length of the first stub.

A resonant frequency of the second DNG unit cell is also determined by a reactance component of a CRLH-TL structure, and the reactance component may be controlled by adjusting at least one of a distance of the second gap, a size of the second patch, permittivity of the carrier, permeability of the carrier, a size of the carrier, a position of the second stub, a width of the second stub, and a length of the second stub.

The first and second DNG unit cells may generate a −1-th order resonance, a 0-th order resonance, and a +1-th order resonance, in which a broadband is formed by combining at least two of the 0-th order resonance of the first DNG unit cell, the +1-th order resonance of the second DNG unit cell, and the +1-th order resonance of the first DNG unit cell.

According to another embodiment of the present invention for achieving the object, there is provided a communication device including the multiband and broadband antenna.

### Advantageous Effects

According to the present invention, it is possible to implement a multiband and broadband antenna independent from the length of the antenna by adjusting reactance components of DNG unit cells.

Therefore, according to the present invention, miniaturization of an antenna can be accomplished, and at the same time, an antenna having multiple bands and wide bandwidth and a communication device including the antenna can be obtained.

### BRIEF DESCRIPTION OF THE DRAWINGS

FIG. 1 is a view showing the entire configuration of a multiband and broadband antenna using a meta material according to an embodiment of the present invention.

FIG. 2 is a view showing the configuration of a power feeding unit of the antenna in FIG. 1 in detail.

FIGS. 3 and 4 show equivalent circuit diagrams of the antenna in FIG. 1.

FIG. 5 shows a dispersion diagram of the antenna in FIG. 1.

FIG. 6 is a view showing an example of actually implementing a multiband and broadband antenna using a meta material according to an embodiment of the present invention.

FIG. 7 is a graph showing return losses of the antenna in FIG. 6.

FIGS. 8 to 10 are radiation patterns of the antenna in FIG. 6, shown on the x-y plane, x-z plane and y-z plane.

FIG. 11 is a view showing efficiencies and maximum gains of a multiband and broadband antenna using a meta material according to an embodiment of the present invention, respectively measured in GSM850/1800/1900, WCDMA and WiBro bands.

### BEST MODE FOR CARRYING OUT THE INVENTION

In the following detailed description, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numbers refer to the same or similar functionality throughout the several views.

Hereinafter, preferred embodiments of the present invention will be described in more detail with reference to the accompanying drawings. The preferred embodiments are merely provided to allow those skilled in the art to easily implement the present invention.

### Preferred Embodiment of the Present Invention

Entire Configuration of Multiband and Broadband Antenna

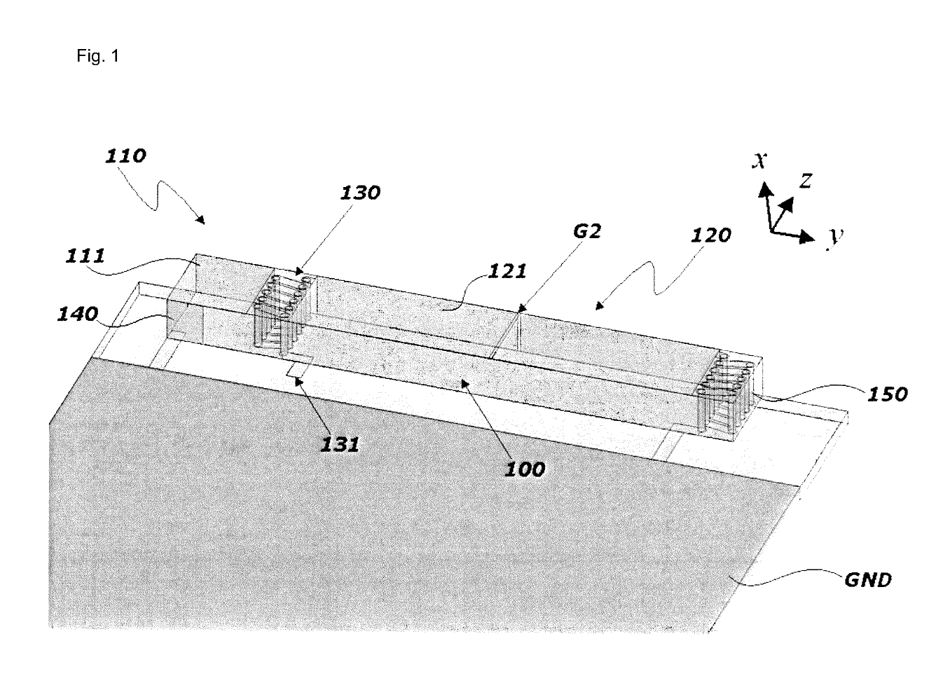

FIG. 1 is a view showing the entire configuration of a multiband and broadband antenna using a meta material according to an embodiment of the present invention.

The meta material is a material or an electromagnetic structure artificially designed to have special electromagnetic characteristics that cannot be generally found in the nature, and in the technical field in general and in this specification, the meta material is a material having a negative permittivity or permeability or an electromagnetic structure thereof.

Such a material (or a structure) is also referred to as a Double Negative (DNG) material in that it has two negative parameters. In addition, a material having only a negative permittivity is referred to as an Epsilon Negative (ENG) material. In addition, the meta material has a negative reflection coefficient due to the negative permittivity and permeability and accordingly is referred to as a Negative Refractive Index (NRI) material. The meta material was first studied by a Russian physicist, V. Veselago, in 1967, and its specific implementation methods and applications are studied and attempted recently after 30 years from the first study.

Due to the characteristics described above, electromagnetic waves are transmitted by the Fleming's left hand law, not by the right hand law, in the meta material. That is, the direction of phase propagation (the direction of phase velocity) of the electromagnetic waves is opposite to the direction energy propagation (the direction of group velocity), and thus a signal passing through the meta material has a negative phase delay. Accordingly, the meta material is also referred to as a Left-handed Material (LHM). In addition, the meta material has a characteristic such that the relation between β (a phase constant) and ω (a frequency) is non-linear and a characteristic curve of the meta material also exists in the left half plane of the coordinate plane. A phase difference dependent on the frequency is small in the meta material due to the non-linear characteristic, and thus a broadband circuit can be implemented, and since a phase shift is not proportional to the length of a transmission line, a small-scaled circuit can be implemented.

As shown in FIG. 1, the multiband and broadband antenna of the present invention may include one or more double negative (hereinafter, referred to as DNG) unit cells using the meta material described above. Although the antenna can be configured with any number of DNG unit cells if the number of the DNG unit cells is one or more, an example of an antenna having two DNG unit cells will be described hereinafter for the convenience of explanation.

In FIG. 1, the DNG unit cells are referred to as a first DNG unit cell 110 and a second DNG unit cell 120, respectively. Here, both of the first and second DNG unit cells 110 and 120 may be a 0-th order resonator using a meta material.

The first and second DNG unit cells 110 and 120 may be configured to respectively include a patch 111 and 121 functioning as an antenna radiator, and the patches 111 and 121 can be formed on a certain carrier 100. If the carrier 100 is formed in a general rectangular parallelepiped shape, the patches 111 and 121 can be formed on at least two surfaces of the carrier 100 in a folded shape. Meanwhile, the carrier 100 may be a material having a certain permittivity ρ, a certain permeability μ or both of the certain permittivity and permeability. For example, although Flame Retardant Type 4 (FR4) having a permittivity of about 4.5 can be used as the carrier 100, it is not limited thereto, and a variety of dielectric materials or magnetic materials can be used as the carrier 100.

Meanwhile, a power feeding unit 130 for supplying power to the first and second patches 111 and 113 so as to allow the patches to function as a radiator of the antenna can be formed between the first and second DNG unit cells 110 and 120.

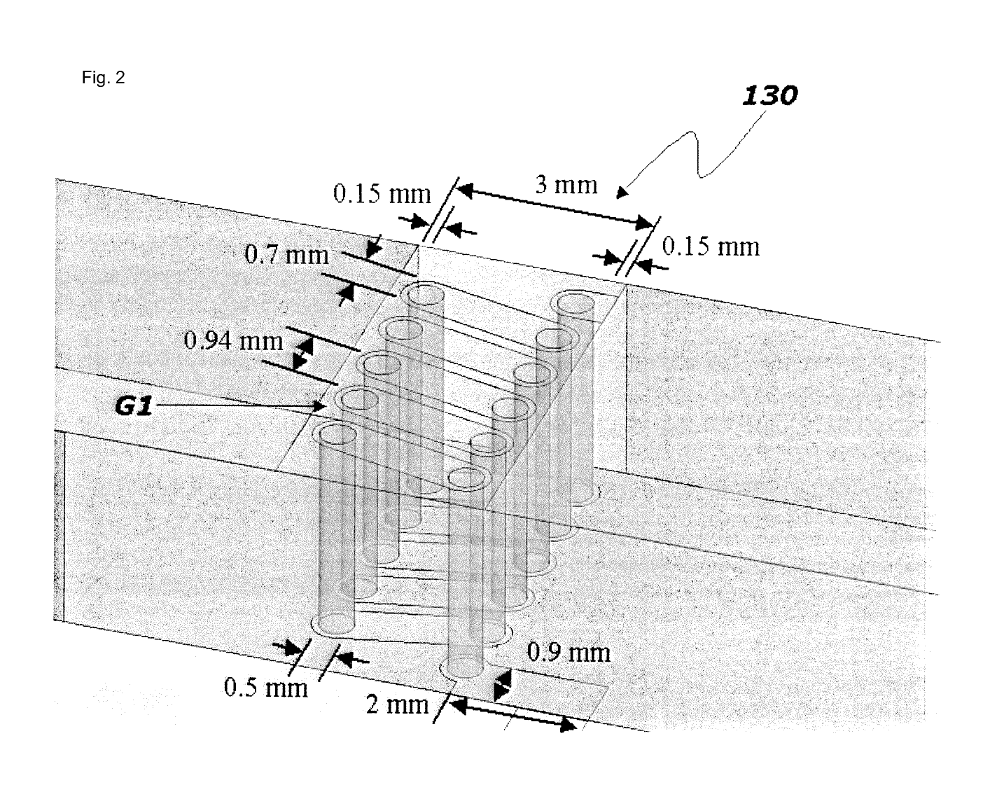

FIG. 2 is a view showing the configuration of the power feeding unit 130 according to an embodiment of the present invention in detail. Although specific numerical values are shown as an example in FIG. 2, the values are only an example of an implementation, and it is apparent that the present invention is not limited thereto.

As shown in FIG. 2, the power feeding unit 130 may be a power feeding line of a helical shape extended from one surface of the carrier 100 to another surface. Referring to FIG. 2, the power feeding unit 130 can be formed such that the power feeding line extended from a power feeding point 131 alternately passes through the bottom and top surfaces of the carrier 100 and, finally, electrically connects to the second patch 121 of the second DNG unit cell 120. Although it is shown in FIG. 2 that the power feeding line included in the power feeding unit 130 is extended from the bottom surface of the carrier 100 and terminated on the top surface of the carrier 100, it is not limited thereto undoubtedly. As shown in FIG. 2, although power cannot be directly supplied to the first patch 111 of the first DNG unit cell 110 since the power feeding line extended from the power feeding point 131 is electrically connected only to the second patch 121 of the second DNG unit cell 120, coupling power feed can be provided by the gap formed between the first patch 111 and the power feeding unit 130. That is, although the first patch 111 does not have a direct electrical connection to the power feeding unit 130, the coupling power feed can be provided since an electromagnetic connection is established. Further higher reliability of the coupling power feed can be attained as the power feeding unit 130 is configured with a power feeding line of a helical shape. Meanwhile, the gap G1 formed between the first patch 111 and the power feeding unit 130 functions as a series capacitance component for operating the first DNG unit cell 110 as a double-negative unit cell, and a resonant frequency can be tuned by adjusting the distance of the gap G1. This will be described below in detail.

On the other hand, a certain gap G2 formed on the second patch 121 of the second DNG unit cell 120 may also function as a series capacitance component for operating the second DNG unit cell 120 as a double negative unit cell. A resonant frequency of the second DNG unit cell 120 may be tuned by adjusting the gap G2. This will be described below in detail.

In addition, the first and second DNG unit cells 110 and 120 may include a stub 140 and 150, respectively. Specifically, one ends of the stubs 140 and 150 may be respectively connected to the termination point of the first patch 111 of the first DNG unit cell 110 and the termination point of the second patch 121 of the second DNG unit cell 120, and the other ends of the stubs 140 and 150 can be connected to the ground surface GND. The stub 140 of the first patch 111 side can be formed on at least one surface of the carrier 100 in a region where the first DNG unit cell 110 is formed, and the stub 150 of the second patch 121 side can be implemented in a helical shape at least at a part of a region where the second DNG unit cell 120 is formed. The stub 150 of a helical shape can be configured to be similar to the shape of the power feeding unit 130. For example, as shown in FIG. 1, the stub 150 is configured to be extended from the second patch 121 on the top surface of the carrier 100, alternately passes through the top and bottom surfaces of the carrier 100, and finally connects to the ground surface GND. The stubs 140 and 150 may function as a parallel inductance component when the first and second DNG unit cells 110 and 120 operate as a negative unit cell, and the resonant frequency can be finely tuned by adjusting the position, width, and length of the stubs 140 and 150.

Meanwhile, although it is not shown in FIG. 1, load inductors for tuning the resonant frequencies of the first and second DNG unit cells 110 and 120 may be additionally inserted between the power feeding point 131 and the ground surface GND, and between the stubs 140 and 150 and the ground surface GND.

Hereinafter, the operation of the multiband and broadband antenna will be described in detail based on the equivalent circuits of the antenna.

Equivalent Circuit Diagrams

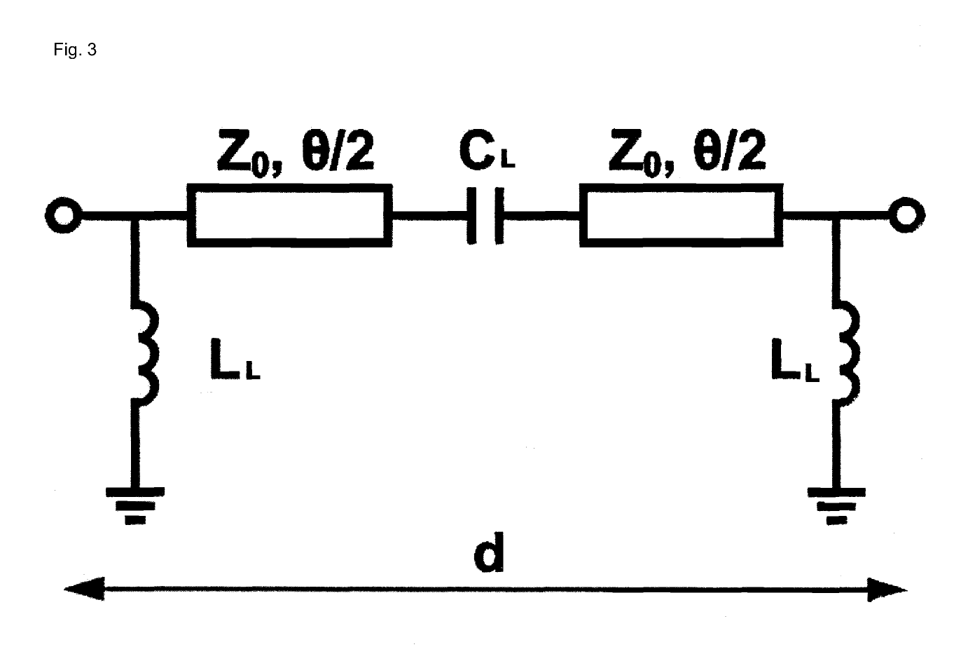

FIG. 3 shows an equivalent circuit diagram of the first and second DNG unit cells 110 and 120 of the multiband and broadband antenna in FIG. 1. The first and second DNG unit cells 110 and 120 may function as a meta material Composite Right/Left Handed Transmission Line (CRLH-TL) circuit by the circuit shown in FIG. 3.

As shown in FIG. 3, the first and second DNG unit cells 110 and 120 functioning as a CRLH-TL circuit can be equalized to include one series capacitor C_{L} and two parallel inductors L_{L}.

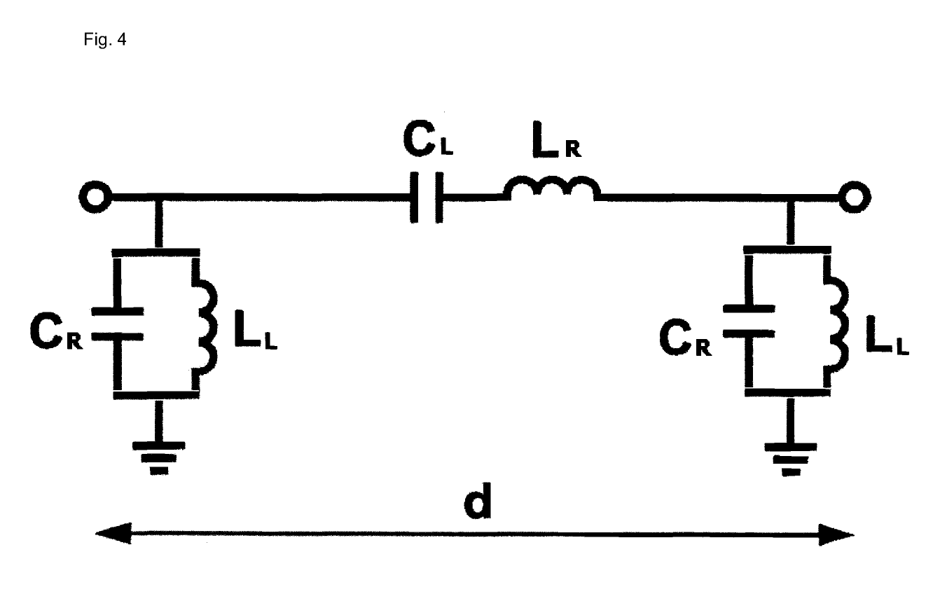

Meanwhile, the first and second DNG unit cells 110 and 120 have a characteristic impedance of Z₀ when they are configured as a general antenna, and the characteristic impedance Z₀ can be expressed as a parallel capacitor component and a series inductor component. FIG. 4 is an equivalent circuit diagram expressing the characteristic impedance Z₀ as a parallel capacitor C_{R} component and a series inductor L_{R} component.

First, equalizing the circuit in FIG. 4 for the first DNG unit cell 110, the series capacitor C_{L} can be equalized to the gap G1 formed between the first patch 111 and the power feeding unit 130, and the parallel inductor L_{L} can be equalized to the inductance component formed between the stub 140 and the ground surface GND. In addition, the parallel capacitor C_{R} can be equalized to the capacitance component formed between the first patch 111 and the ground surface GND, and the series inductor L_{R} can be equalized to the inductance component formed by the first patch 111.

On the other hand, equalizing the circuit in FIG. 4 for the second DNG unit cell 120, the series capacitor C_{L} can be equalized to the gap G2 formed on the second patch 121, and the parallel inductor L_{L} can be equalized to the inductance component formed between the stub 150 and the ground surface GND. In addition, the parallel capacitor C_{R} can be equalized to the capacitance component formed between the second patch 121 and the ground surface GND, and the series inductor L_{R} can be equalized to the inductance component formed by the second patch 121.

As described above, in the first DNG unit cell 110, the capacitance value of the series capacitor C_{L} can be tuned by adjusting the gap G1 formed between the first patch 111 and the power feeding unit 130, and the inductance value of the parallel inductor L_{L} can be tuned by adjusting the stub 140. The capacitance vale of the parallel capacitor C_{R} can be tuned by adjusting the gap formed between the first patch 111 and the ground surface GND, and the inductance value of the series inductor L_{R} can be tuned by adjusting the size and the like of the first patch 111.

In addition, in the second DNG unit cell 120, the capacitance value of the series capacitor C_{L} can be controlled by adjusting the gap G2 formed on the second patch 121, and the inductance value of the parallel inductor L_{L} can be controlled by adjusting the stub 150, and the capacitance vale of the parallel capacitor C_{R} can be controlled by adjusting the gap formed between the second patch 121 and the ground surface GND. In addition, the inductance value of the series inductor L_{R} can be controlled by adjusting the size and the like of the second patch 121.

In this manner, overall resonant frequency of the DNG unit cells 110 and 120 is tuned, and a miniaturized antenna independent from the length d of the entire antenna can be implemented by using the characteristics of the meta material as described above.

Dispersion Diagram

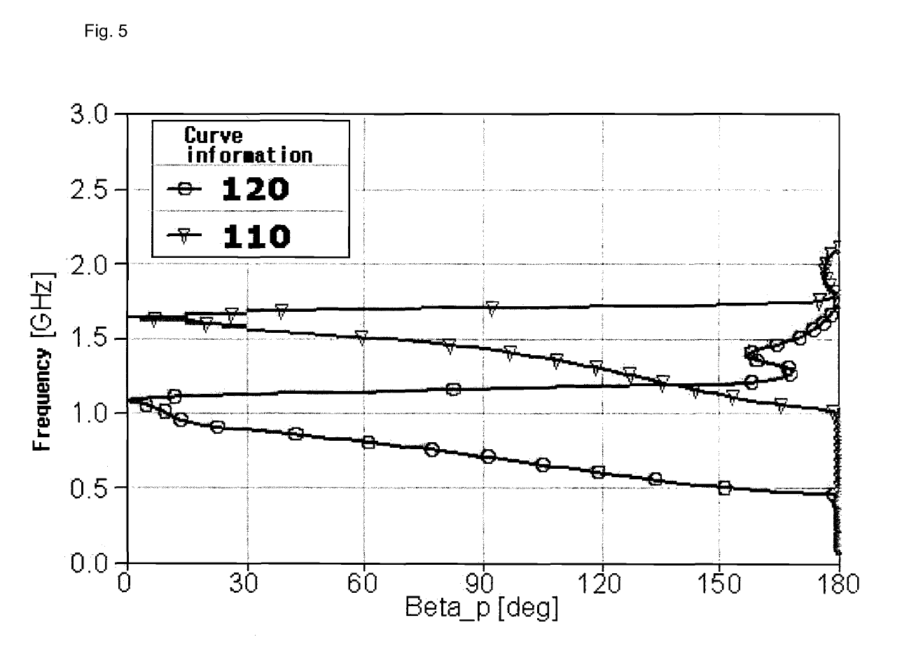

FIG. 5 a view showing a dispersion diagram for the first and second DNG unit cells 110 and 120 according to an embodiment of the present invention.

In the diagram shown in FIG. 5, the curve expressed using inverted triangles (∇) is a dispersion diagram for the first DNG unit cell 110, and the curve expressed using circles (◯) is a dispersion diagram for the second DNG unit cell 120.

Referring to FIG. 5, it is understood that the first and second DNG unit cells 110 and 120 may obtain a 0-th order resonant frequency and a negative order (−) resonant frequency, as well as a positive order (+) resonant frequency, depending on frequency characteristic.

Specifically, it is understood that the first DNG unit cell 110 generates a −1-th order resonance, a 0-th order resonance, and a +1-th order resonance around frequencies of about 1 GHz, 1.7 GHz, and 2.1 GHz respectively, and the second DNG unit cell 120 generates a −1-th order resonance, a 0-th order resonance, and a +1-th order resonance around frequencies of about 0.5 GHz, 1.05 GHz, and 1.8 GHz respectively. Relatively comparing the resonant frequencies of the first and second DNG unit cells 110 and 120, since the resonant frequency of the first DNG unit cell 110 is formed to be higher than that of the second DNG unit cell 120 at the same order, the first DNG unit cell 110 can be referred to as a high band DNG unit cell, and the second DNG unit cell 120 can be referred to as a low band DNG unit cell.

On the other hand, the −1-th order and 0-th order resonant frequencies of the second DNG unit cell 120 can be a low band operating frequency of the entire antenna system. In addition, since the 0-th order resonant frequency of the first DNG unit cell 110 is adjacent to the +1-th order resonant frequency of the second DNG unit cell 120, bands of the two resonant frequencies are combined, and thus the frequencies may function as a broad-banded high band operating frequency in the entire antenna system. Furthermore, the 0-th order resonant frequency of the first DNG unit cell 110, the +1-th order resonant frequency of the second DNG unit cell 120, and the +1-th order resonant frequency of the first DNG unit cell 110 can be combined to function as a broad-banded high band operating frequency in the entire antenna system.

Simulation for Example of Actual Implementation

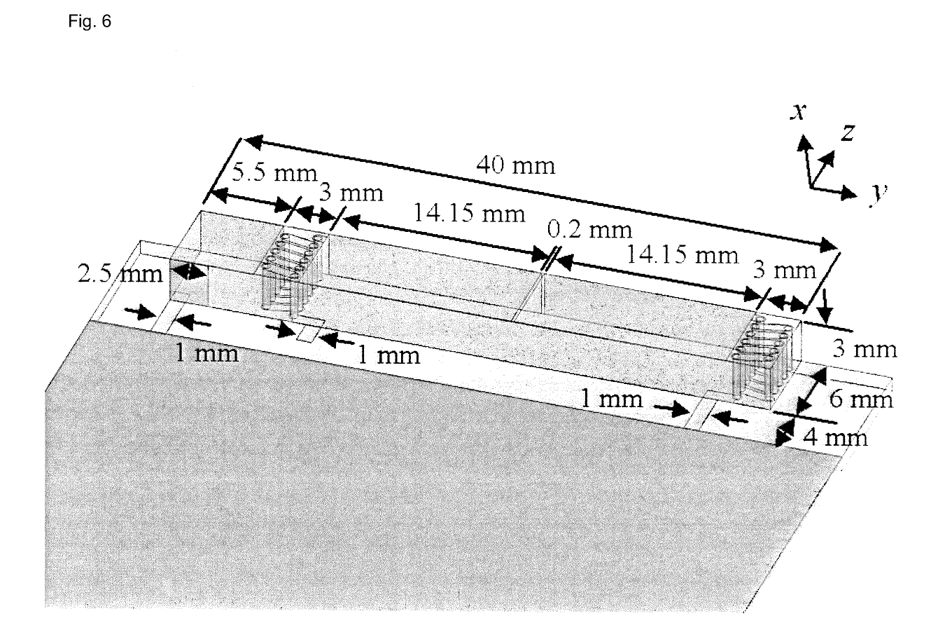

FIG. 6 is a view showing an example of actual implementation of a multiband and broadband antenna according to an embodiment of the present invention. An FR4 dielectric material having a permittivity of 4.5 and a dimension of 40 mm×6 mm×3 mm is used as the carrier 100. Specific implementation sizes of the other constitutional components are shown in FIG. 6 in detail, and thus they will not be described. In addition, since reference symbols of the drawing for respective constitutional components are the same as those shown in FIG. 1, the symbols are not shown in the figure for simplicity of the drawing.

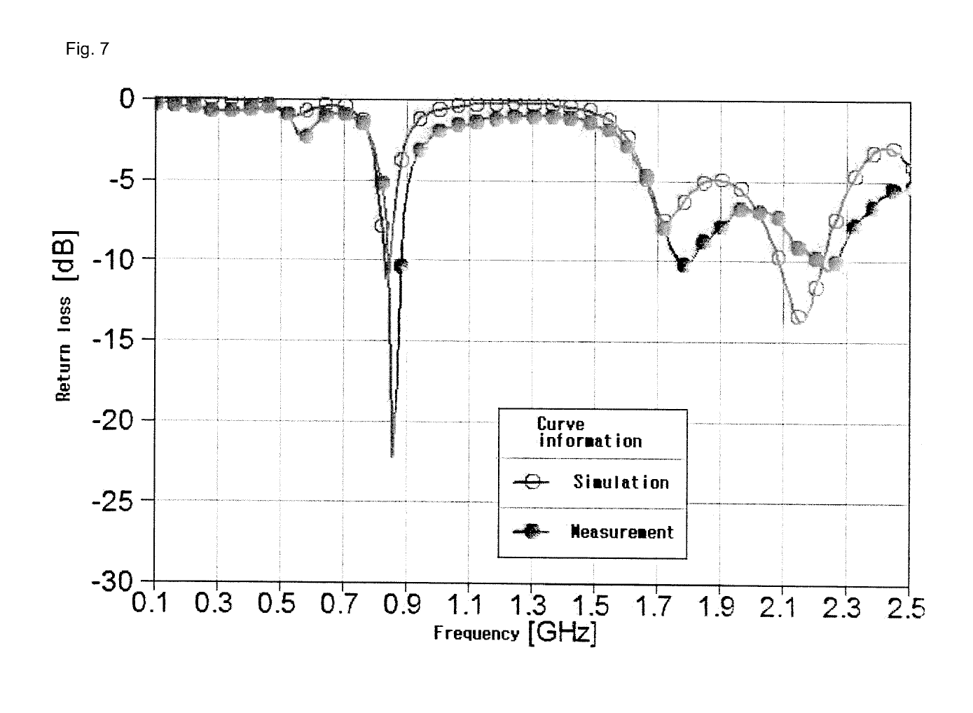

FIG. 7 is a graph showing return losses of the multiband and broadband antenna in FIG. 6. In the graph shown in FIG. 7, the curve indicated by hollow circles (◯) is a result of simulation, and the curve indicated by solid circles () is a result of actual measurement.

Referring to FIG. 7, it is understood that the entire antenna system shows a low frequency resonance in a frequency band around about 0.8 GHz and shows a high frequency resonance in a frequency band between about 1.7 to 2.4 GHz. Specifically, it is understood that although the second DNG unit cell 120 generates the −1-th order resonance around about 0.6 GHz, it does not function as a low frequency resonant band in the entire antenna system since the resonance is weak, and a resonant frequency around about 0.8 GHz generated by the 0-th order resonance can be appeared as a resonant frequency of a low frequency band. In addition, it is understood that the 0-th order resonance around about 1.8 GHz of the first DNG unit cell 110 and the +1-th order resonance around about 2.2 GHz of the second DNG unit cell 120 are combined, and thus a broad-banded high frequency resonance is implemented on the whole.

Result of Measuring Radiation Patterns

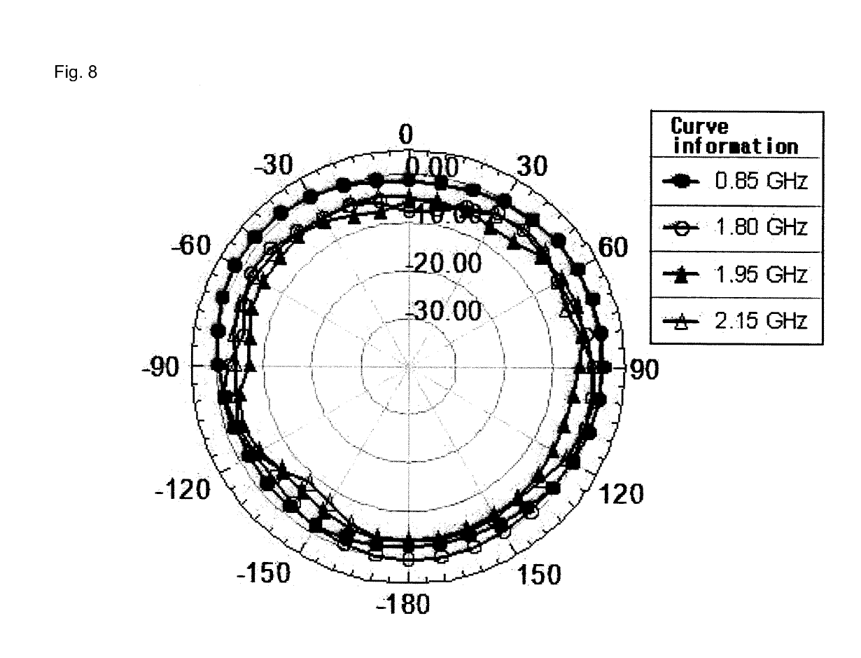

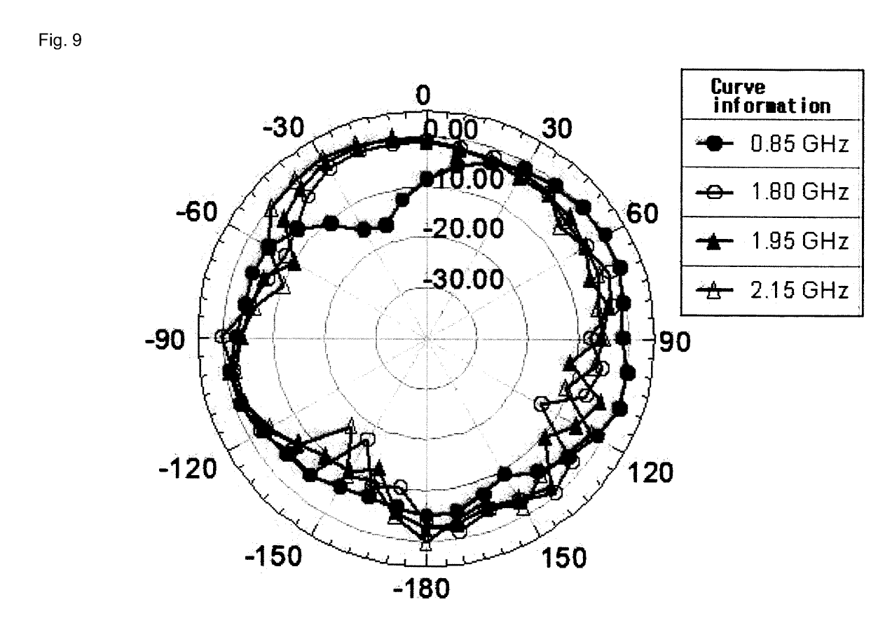

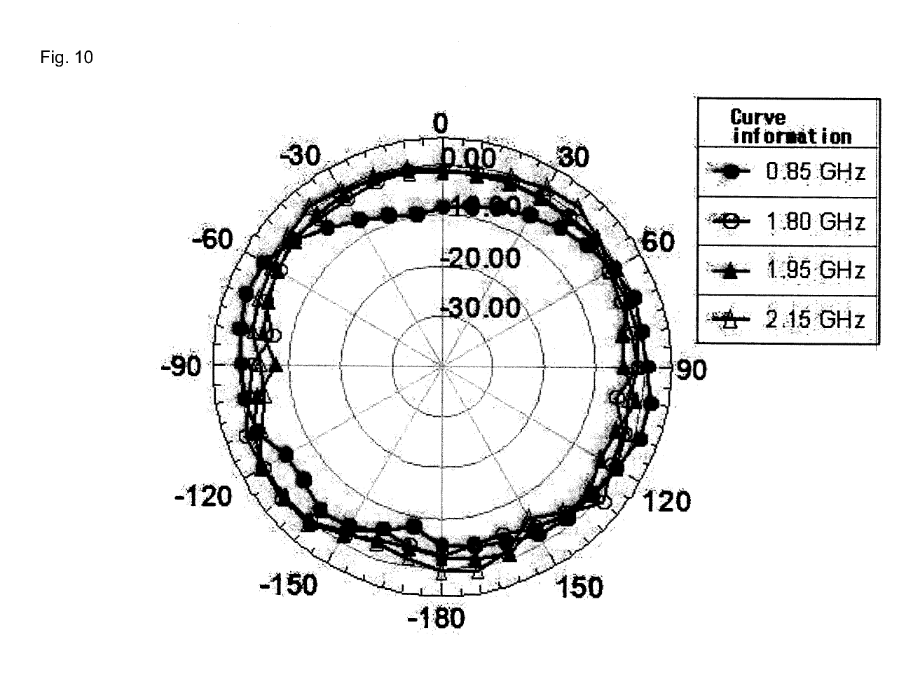

FIGS. 8 to 10 are views showing radiation patterns of a multiband and broadband antenna according to an embodiment of the present invention, shown on the x-y plane, x-z plane and y-z plane, respectively.

Referring to FIGS. 8 to 10, it is understood that the antenna system of the present invention shows a radiation pattern having omni-directionality. Accordingly, the antenna system of the present invention is sufficient to be applied to a mobile terminal.

Efficiency and Maximum Gain of Antenna in Each Band

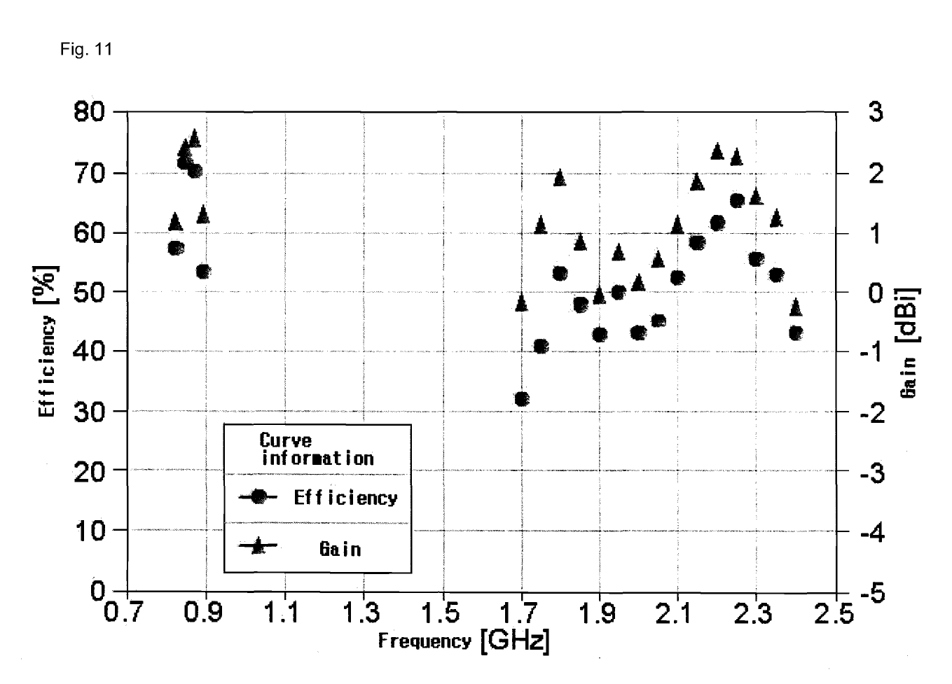

FIG. 11 is a view showing efficiencies and maximum gains of a multiband and broadband antenna according to an embodiment of the present invention, respectively measured in GSM850/1800/1900, WCDMA, and WiBro bands.

As is understood from the above descriptions and FIG. 11, the antenna of the present invention operates as a multiband and broadband antenna having low band and high band resonant frequencies and, particularly, shows broadband characteristics at a high band resonant frequency.

The multiband and broadband antenna of the present invention may adjust resonant frequency characteristics of the DNG unit cell by adjusting the shape of the power feeding unit (the position, width and length of the power feeding line), the gap formed between the first patch and the power feeding unit, the gap formed on the second patch, the position of the stub, the width of the stub, the length of the stub, and the like. However, the present invention is not limited thereto, and if reactance of the DNG unit cells can be adjusted, a resonant frequency can be tuned by adjusting the shape of all constitutional components included in the antenna system, such as configurations other than the configuration described above, e.g., the permittivity of the carrier, the size of the carrier, the shape of the carrier, the number of unit cells, and the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. Modules, functional blocks, or means of the present embodiment may be embodied as any of various commonly-used devices, such as electronic circuits, integrated circuits, application specific integrated circuits (ASICs), or the like, where each of modules, functional blocks, or means may be embodied as individual devices or two or more of the modules, the functional blocks, or the means may be unified to a single device. While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multiband and broadband antenna comprising:
a power feeding unit formed in at least a portion of a carrier; and
at least one Double Negative (DNG) unit cell formed on the carrier, for receiving power from the power feeding unit and functioning as a Composite Right/Left Handed Transmission Line (CRLH-TL).

2. The antenna according to claim 1, wherein two DNG unit cells are formed, in which a first DNG unit cell of the two DNG unit cells is formed on a left side of the power feeding unit and comprises a first patch and a first stub formed on at least one surface of the carrier, and a second DNG unit cell of the two DNG unit cells is formed on a right side of the power feeding unit and comprises a second patch and a second stub formed on at least one surface of the carrier.

3. The antenna according to claim 2, wherein the power feeding unit comprises a power feeding line of a helical shape, and the power feeding line of a helical shape is formed to have a first gap to be spaced from the first DNG unit cell to perform coupling power feeding and directly connected to the second DNG unit cell to perform direct power feeding.

4. The antenna according to claim 2, wherein a second gap is formed in at least a portion of the second patch.

5. The antenna according to claim 2, wherein the first stub and the second stub are connected to a ground surface formed on a substrate which is formed to be independent from the carrier.

6. The antenna according to claim 5, wherein inductors are formed between at least one of the power feeding unit, the first stub and the second stub and the ground surface.

7. The antenna according to claim 2, wherein the second stub is a stub of a helical shape, in which one end of the stub is connected to the ground surface, and the other end of the stub is connected to the second patch.

8. The antenna according to claim 3, wherein a resonant frequency of the first DNG unit cell is determined by a reactance component of a CRLH-TL structure, and the reactance component is controlled by adjusting at least one of a position of the power feeding line, a width of the power feeding line, a length of the power feeding line, a distance of the first gap, a size of the first patch, permittivity of the carrier, permeability of the carrier, a size of the carrier, a position of the first stub, a width of the first stub, and a length of the first stub.

9. The antenna according to claim 4, wherein a resonant frequency of the second DNG unit cell is determined by a reactance component of a CRLH-TL structure, and the reactance component is controlled by adjusting at least one of a distance of the second gap, a size of the second patch, permittivity of the carrier, permeability of the carrier, a size of the carrier, a position of the second stub, a width of the second stub, and a length of the second stub.

10. The antenna according to claim 2, wherein the first and second DNG unit cells generate a −1-th order resonance, a 0-th order resonance, and a +1-th order resonance, in which a broadband is formed by combining at least two of the 0-th order resonance of the first DNG unit cell, the +1-th order resonance of the second DNG unit cell, and the +1-th order resonance of the first DNG unit cell.

11. A communication device including the multiband and broadband antenna comprising:
a power feeding unit formed in at least a portion of a carrier; and
at least one Double Negative (DNG) unit cell formed on the carrier, for receiving power from the power feeding unit and functioning as a Composite Right/Left Handed Transmission Line (CRLH-TL).
